(19) United States
(12) Patent Application Publication
(10) Pub. No.: US 2026/0093760 A1
(43) Pub. Date: Apr. 2, 2026

(54) CONTENT FILTERING FOR SLOT OPTIMIZATION FOR SPONSORED SEARCHES USING MACHINE LEARNING TECHNIQUES

(71) Applicant: Walmart Apollo, LLC, Bentonville, AR (US)

(72) Inventors: Nirajana Prasad Moleyar, Sunnyvale, CA (US); Zhaodong Wang, Mountain View, CA (US); Musen Wen, Mountain View, CA (US); Ranjit Kumar Pedapati, Saratoga, CA (US); Vamsee Tangirala, Seattle, WA (US); Parth Mukeshkumar Pandya, Santa Clara, CA (US); Valeriy Valeryevich Pelyushenko, San Jose, CA (US); Rajesh Garigipati, Dublin, CA (US); Kavita Krithivasan, Seattle, WA (US); Himanshu Kumar Singh, Foster City, CA (US); Chintan Jagdish Rita, Sunnyvale, CA (US); Kuang-chih Lee, Fremont, CA (US)

(73) Assignee: Walmart Apollo, LLC, Bentonville, AR (US)

(21) Appl. No.: 18/902,182

(22) Filed: Sep. 30, 2024

(51) Int. Cl. G06F 16/9535; G06F 16/25

(52) U.S. Cl. CPC G06F 16/9535; G06F 16/258

(57) ABSTRACT

A system including a processor and a non-transitory computer-readable medium storing computing instructions that, when executed on the processor, cause the processor to execute operations: identifying intent features within multiple terms of a search query; retrieving recommendations mapped to a candidate item based on the intent features; matching, using a rules engine, the intent features to a first recommendation of the recommendations, wherein the first recommendation is associated with first segment slots; generating, using a machine learning model, a second recommendation using a database, wherein the second recommendation is associated with (i) second segment slots or (ii) remaining slots of the first segment slots; and populating the first segment slots and the second segment slots on a webpage corresponding to the intent features of the search query. Other embodiments are described.

### TECHNICAL FIELD

This disclosure relates generally to technology for content filtering for slot optimization for sponsored searches using machine learning techniques.

### BACKGROUND

Generally, items are often displayed in a list or grid style format on a search page, in which the top slots are often reserved as placeholders for items sponsored by a vendor. Conventional search engines are able to display multiple items for a search query with terms identifying an item or a product category. Identifying sponsored items to fill the top slots of the search page can be challenging and time consuming when a search query includes multiple terms searching for an item.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative activity diagram of an example of the elements included in the circuit boards inside a chassis of the computer system of FIG. 1;

FIG. 3 illustrates a block diagram of a system that can be used for filtering content of multiple sponsored searches to match the features and/or intents in a search query, according to an embodiment;

FIG. 4 illustrates a flow diagram of generating recommendations of content mapped to candidate items based on the intent features identified in a search query, according to another embodiment;

FIG. 5 illustrates a flow chart for method of filtering content of candidate items to match a predetermined number of intents identified in a search query, according to another embodiment;

FIG. 6 illustrates a flow chart for method of generating a second recommendation, according to another embodiment;

FIG. 7 illustrates a flow chart of a method of predicting a relevance score for a query-item pair, according to an embodiment;

FIG. 8 illustrates a flow chart of a method of predicting whether the second items quality for sponsored slots, according to an embodiment; and

FIG. 9 illustrates a block diagram for a method of a configurable dynamic-reserve 2-phase second price auction, according to an embodiment.

### DESCRIPTION OF EXAMPLES OF EMBODIMENTS

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same or similar elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 1 millisecond, 1 nanosecond, 1 second, or another suitable time delay period.

Various embodiments can include a system. A system can include a processor and a non-transitory computer-readable medium storing computing instructions that, when executed on the processor, cause the processor to execute certain operations. The operations can include identifying intent features within multiple terms of a search query. The operations further can include retrieving recommendations mapped to a candidate item based on the intent features. The operations additionally can include matching, using a rules engine, the intent features to a first recommendation of the recommendations. The first recommendation can be associated with first segment slots. The operations also can include generating, using a machine learning model, a second recommendation using a database. The second recommendation can be associated with (i) second segment slots or (ii) remaining slots of the first segment slots. The operations further can include populating the first segment slots and the second segment slots on a webpage corresponding to the intent features of the search query.

A number of embodiments can include a computer-implemented method. The computer-implemented method can include identifying intent features within multiple terms of a search query. The computer-implemented method further can include retrieving recommendations mapped to a candidate item based on the intent features. The computer-implemented method additionally can include matching, using a rules engine, the intent features to a first recommendation of the recommendations. The first recommendation can be associated with first segment slots. The computer-implemented method also can include generating, using a machine learning model, a second recommendation using a database. The second recommendation can be associated with (i) second segment slots or (ii) remaining slots of the first segment slots. The computer-implemented method further can include populating the first segment slots and the second segment slots on a webpage corresponding to the intent features of the search query.

Several embodiments can include a non-transitory computer-readable medium storing computing instructions that, when executed on a processor, cause the processor to execute certain operations. The operations can include identifying intent features within multiple terms of a search query. The operations further can include retrieving recommendations mapped to a candidate item based on the intent features. The operations additionally can include matching, using a rules engine, the intent features to a first recommendation of the recommendations. The first recommendation can be associated with first segment slots. The operations also can include generating, using a machine learning model, a second recommendation using a database. The second recommendation can be associated with (i) second segment slots or (ii) remaining slots of the first segment slots. The operations further can include populating the first segment slots and the second segment slots on a webpage corresponding to the intent features of the search query.

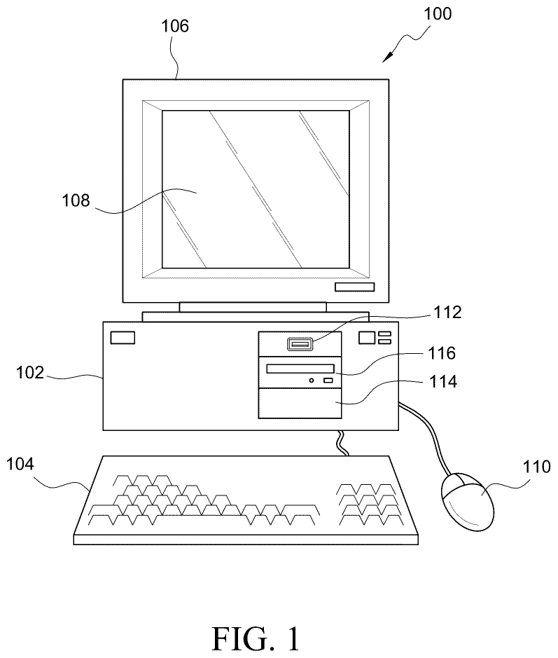

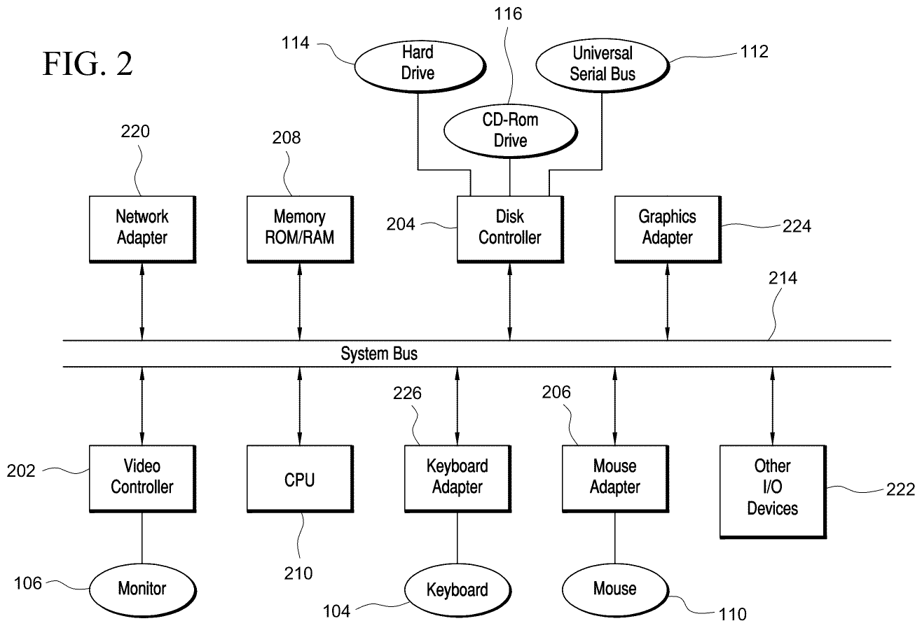

Turning to the drawings, FIG. 1 illustrates an example embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative activity diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Example operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further example operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

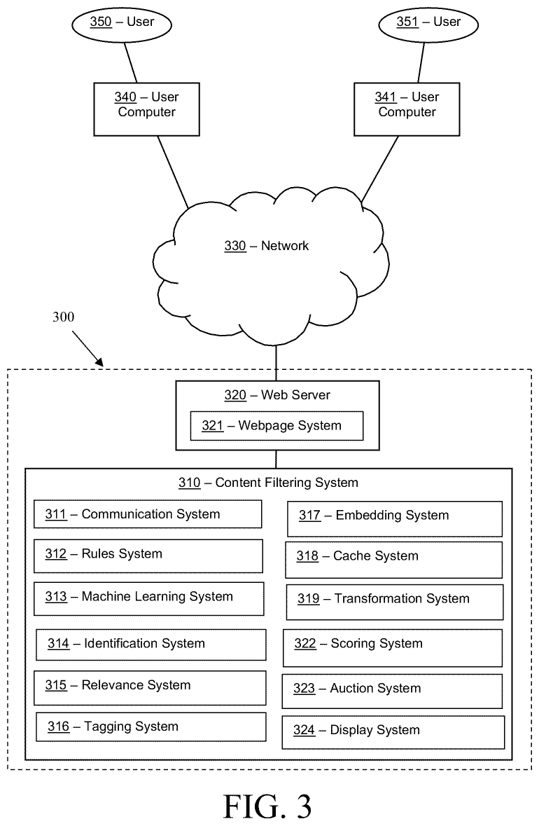

Turning ahead in the drawings, FIG. 3 illustrates a block diagram of a system 300 that can be used for filtering content of multiple sponsored searches to match the features and/or intents in a search query, according to an embodiment. System 300 is merely an example and embodiments of the system are not limited to the embodiments presented herein. The system can be used in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a content filtering system 310 and/or a web server 320. Content filtering system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, content filtering system 310 and/or web server 320. Additional details regarding content filtering system 310 and/or web server 320 are described herein.

In a number of embodiments, each system of content filtering system 310 and/or web server 320 can be a special-purpose computer programed specifically to perform specific functions not associated with a general-purpose computer, as described in greater detail below.

In some embodiments, web server 320 can be in data communication through a network 330 with one or more user computers, such as user computers 340 and/or 341. Network 330 can be a public network, a private network, or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to browse and/or search for items (e.g., products), to add items to an electronic shopping cart, and/or to order (e.g., purchase) items, in addition to other suitable activities.

In some embodiments, an internal network that is not open to the public can be used for communications between content filtering system 310 and/or web server 320 within system 300. Accordingly, in some embodiments, content filtering system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Example mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can include the Virtual Retinal Display™ product, or similar product by the University of Washington of Seattle, Washington, United States of America. Meanwhile, in further specific examples, a limb mountable wearable user computer device can include the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In several embodiments, system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300. In a similar manner, the processors and/or the non-transitory computer-readable media can be local and/or remote to each other.

Meanwhile, in many embodiments, system 300 also can be configured to communicate with and/or include one or more databases. The one or more databases can include a product database that contains content and/or information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Example database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between system 300, network 330, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Example PAN protocol(s) can include Bluetooth, Zigbee, Wireless Universal Serial Bus (USB), Z-Wave, etc.; example LAN and/or WAN protocol(s) can include Institute of Electrical and Electronic Engineers (IEEE) 802.3 (also known as Ethernet), IEEE 802.11 (also known as WiFi), etc.; and example wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, example communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further example communication hardware can include wireless communication hardware including, for example, one or more radio transceivers, one or more infrared transceivers, etc. Additional example communication hardware can include one or more networking components (e.g., modulator-demodulator components, gateway components, etc.).

In many embodiments, content filtering system 310 can include a communication system 311, a rules system 312, a machine learning system 313, an identification system 314, a relevance system 315, a tagging system 316, an embedding system 317, a cache system 318, a transformation system 319, a scoring system 322, an auction system 323, and/or a display system 324. In many embodiments, the systems of content filtering system 310 can be modules of computing instructions (e.g., software modules) stored at non-transitory computer readable media that operate on one or more processors. In other embodiments, the systems of content filtering system 310 can be implemented in hardware. Content filtering system 310 can be a computer system, such as computer system 100 (FIG. 1), as described above, and can be a single computer, a single server, or a cluster or collection of computers or servers, or a cloud of computers or servers. In another embodiment, a single computer system can host content filtering system 310. Additional details regarding content filtering system 310 and the components thereof are described herein.

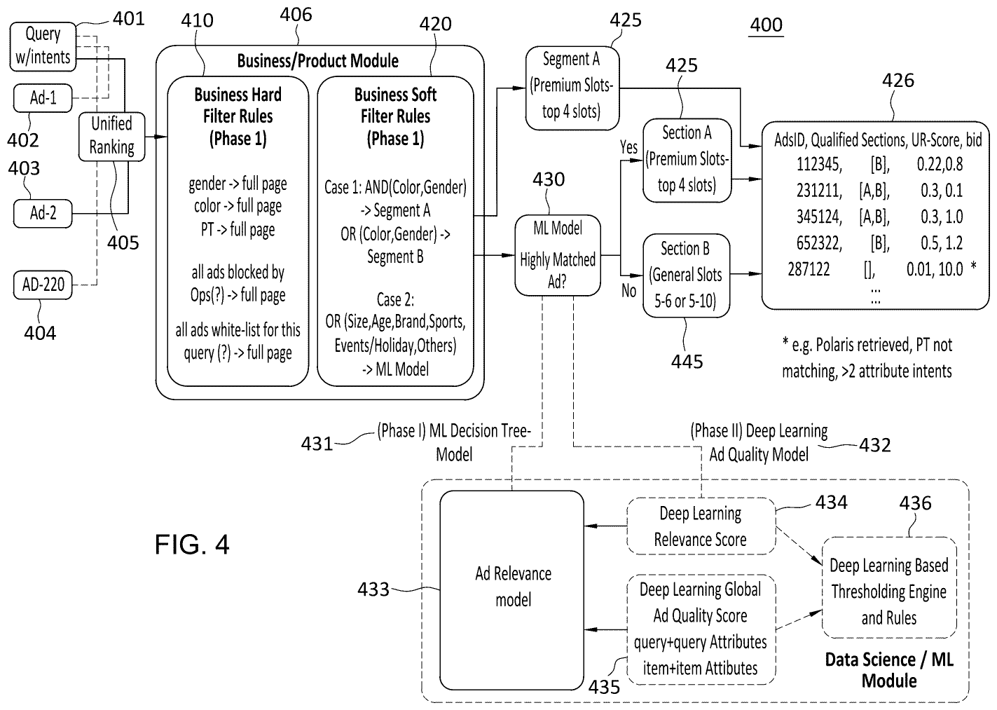

Turning to the drawings, FIG. 4 illustrates a flow diagram for a method 400 of generating recommendations of content mapped to candidate items based on the intent features identified in a search query, according to an embodiment. Method 400 also can include mapping section-based content using a combination of machine learning and rules. Method 400 can be used in many different embodiments and/or examples not specifically depicted or described herein. In some embodiments, the procedures, the processes, and/or the activities of method 400 can be performed in the order presented or in parallel. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as content filtering system 310 and/or web server 320. The processor(s) can be similar or identical to the processor(s) described above with respect to computer system 100 (FIG. 1).

In several embodiments, method 400 can include identifying intent features in a search query with multiple intents 401 and multiple recommendations 402-404. In some embodiments, method 400 also can include filtering and ranking the recommendations 402-404 as input into at least a rules engine 406 for mapping the recommendations to a query-item pair. In various embodiments, method 400 further can include an activity 405 of ranking the multiple recommendations in an ordered sequence (e.g., hierarchical structure) based on a degree or percentage of matching the intent features and/or intent terms of the search query. In some embodiments, the output of activity 405 can include a ranked list or ordered list of recommendations for input into a rules engine 406 and/or a machine learning model 430.

In some embodiments, rules engine 406 can include hard filter rules 410 and soft filter rules 420 that can be used to determine whether or not a recommendation can be placed or displayed in one of the first segment slots 425 (e.g., premium slots). For example, if the intent features match the search query with multiple intents, the recommendation is considered for placement in first segment slots 425, otherwise the recommendations are considered for placement in a second segment slot 445 (e.g., general slots). In several embodiments, method 400 can proceed after rules engine 406 to machine learning model 430.

In several embodiments, if there are not enough recommendations matched to the first segment slots after being filtered through rules engine 406 and/or some of the first segment slots remain as passive slots (empty slots or placeholders), machine learning model 430 determines whether to override the matching rules in rules engine 406. In various embodiments, overriding the matching rule in the rules engine 406 can be due to a matching logic error, a business rule that is outdated, and/or another suitable reason.

In some embodiments, overriding rules engine 406 can include various scenarios that allow the recommendations to re-qualify for first segment slots 425 and/or quality for second segment slots. In various embodiments, overriding rules engine 406 also can allow previously unqualified recommendations as previously filtered through rules engine 406 to qualify or re-qualify for one of the first segment slots 425. In various embodiments, machine learning model 430 also can determine whether recommendations qualify for either a first segment slot 425 or a second segment slot 445 based on a degree or percentage of matching intent features of the search query.

In various embodiments, machine learning model 430 can include mixed machine learning approaches (e.g., an ensemble) including a machine learning models 431 (e.g., Phase I) and/or a machine learning models 432 (e.g., Phase II) to determine whether the group of candidate items matching the intent features of the search query can qualify for placement for first segment slot 425 and/or second segment slot 445. In some embodiments, machine learning model 431 can include a decision tree learning model, an advertisement relevance model 433, and/or another suitable machine learning model. In several embodiments, machine learning model 432 can include a deep learning machine learning model 434 to generate a relevance score for the query-item pair, a deep learning global machine learning model 435 to generate a quality score for the query-item pair, a deep learning thresholding machine learning model 436 to generate thresholds based on a thresholding engine and rules and/or another suitable deep learning model.

In several embodiments, method 400 can include generating a summary 426 showing various data points for each candidate item after being processed through rules engine 406 and machine learning model 430. In various embodiments, summary 426 also can display an output of each item of a query-item pair by identification number, qualification status, relevance scores, and/or another data point. In some embodiments, summary 426 can include candidate item (e.g., AdsID) identification, qualified sections [A,B], and a relevance score, bid score. As an example, candidate item no. 112345 is qualified for Section B or a general slot (e.g., second segment slots) with a relevance score of 0.22 and a bid score of 0.8.

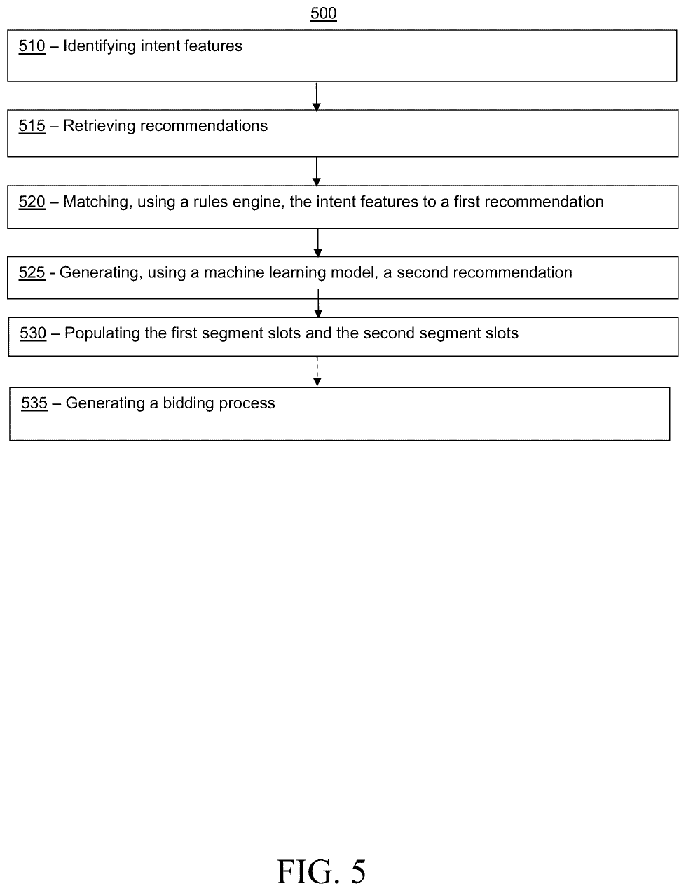

Turning ahead in the drawings, FIG. 5 illustrates a flow chart for a method 500 of filtering content of candidate items to match each of the predetermined number of intents identified in a search query, according to another embodiment. In several embodiments, method 500 also can be a method of matching filtered content of second candidate items to match a number of the predetermined number of intents identified in the search query. Method 500 is merely an example and is not limited to the embodiments presented herein. Method 500 can be utilized in many different embodiments and/or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as content filtering system 310 and/or web server 320. The processor(s) can be similar or identical to the processor(s) described above with respect to computer system 100 (FIG. 1).

Referring to the drawings, FIG. 5 can include an activity 510 of identifying intent features within multiple terms of a search query. In some embodiments, a search query can include a head query, a torso query, or a tail query. In some embodiments, FIG. 5 can be similar or identical to FIG. 4.

In various embodiments, the one or more intent features can include one or more of an age, a size, a color, a gender, a brand, and/or another suitable intent feature.

In general, each search query can fall into different categories (e.g., buckets) that can include head queries (a top third of search queries), torso queries (a second third) of search queries or tail or end queries (last third of queries). Generally, both the head and torso queries can include types of intents or intent features that can match multiple candidate items with a high frequency of relevance, which can be selected for a slot in the one or more first segment slots on a webpage. As an example of head queries and/or torso queries, a search query requesting a type of cereal and/or a brand name of an item can receive frequent hits matching the search query terms. In following the example of head queries and/or torso queries, when each of the candidate items, using the rules engine, match each of the search query intents, then each of the candidate items are qualified for a slot that is sponsored by a vendor on a webpage whether the slot is a premium slot or a general slot. In many embodiments, each location of each of the candidate items, as qualified, can be determined by using a bidding system as further described below in connection with an activity 535.

In many embodiments, tail or end search queries can include multiple terms with multiple intents in one search query. In some embodiments, each of the multiple intents or a number of the intents in the search query can be mapped to one or more candidate items. As an example, a tail search query can include “toys for three-year-old girls.” In following this example, identifying the one or more intent features present in the query request can include identifying more than one intent feature, such as, an age intent (e.g., three-year-old), a gender intent (e.g., female), or a category intent (e.g., toys). In following with the tail search query example, a user or customer is searching for a toy suitable for a girl that is three years old causing the search engine to search data based on the search query terms in the catalog or database. In such a scenario, if a search engine uses the search terms as entered in the search query, many items (e.g., sponsored items) can be missed or overlooked since the items were identified or described using other descriptor terms that were uploaded into the catalog or database by a vendor or third-party, thereby eliminating an otherwise good match of a sponsored candidate item for this query search. In this scenario, the query does not match the item as the terms used are not exact or matching. In some embodiments, a rules engine can add new rules to standardize terms used for both the query side and the item side in a query-item pair that more efficiently assists in matching and mapping the query intents with candidate items. By using standardized terms in both the query side and intent side of a query-item pair, the technology is improved showing a greater degree of accuracy, efficiency, and speed used to retrieve items than by using less accurate, less efficient and slower conventional search engines.

In several embodiments, activity 510, the rules engine also can include standardizing terms into a central or common framework by mapping the one or more context intents into a common group or list. As an example of the central or common framework, mapping the term “three-year-old” to a standardized group or list can include variations of terminology for an age intent, such as: pre-school, pre schools, pre-schools, pre-school, preschools, child, children, toddler, toddlers, etc.

In several embodiments, standardizing intents using a common framework (e.g., list or group) for both the query side and the item side is advantageous by further improving accuracy and speed of search engines used in a computing device.

In various embodiments, FIG. 5 also can include an activity 515 of retrieving recommendations mapped to a candidate item based on the intent features. In some embodiments, activity 515 can include using one or more channels to retrieve the recommendations that are mapped to one or more candidate items based on the one or more intent features. In several embodiments, recommendations also can be referred to interchangeably as items, sponsored items, candidate items, and/or another suitable term.

In various embodiments, the one or more channels can include one or more search engines or search algorithms. Some examples of search engines can include Polaris, Solr, Vector, and/or another suitable search engine. In some embodiments, the search engines can use data mining to search for terms uploaded in catalog item information and/or another suitable item descriptor. For example, the search engine does not search for terms associated with an item title of an item which is the information displayed with the item in a slot on a webpage. In following this example, an item title can include a description of an item as shown below an item displayed on the webpage. In such cases, the item title description can include a summary of descriptors or a group of highlights of the item without describing the type of catalog data that is uploaded for the item by a vendor or third party. In several embodiments, the one or more channels can search for catalog, vendor, and/or a third-party data as uploaded into a digital space or an electronic environment. For example, catalog data can include various descriptors for the item based on the type of item. An example list of descriptors of catalog data can include: a brand, a manufacturer part number, an age group, a power type, an educational focus, a color, an assembled product weight, a manufacturer, and/or another suitable descriptor of the item. In many embodiments, a search engine searches the catalog item information for descriptors, metadata, and/or other data points of the item.

In some embodiments, after all the recommendation and/or items have been filtered using the standardization techniques described above, activity 515 also can include ranking, using a ranking algorithm, the items for a top number of items that qualify as matches to the query terms, such as the unifier ranking algorithm of activity 405 (FIG. 4). As an example, after matching the query terms (query side) with the candidate items (item side) of a query-item pair, a top number of items are sorted and retained since these items qualify for a number of premium and/or general slots reserved on a web page (e.g., search webpage). Such a top number of items can be 10, 15, 20, and/or another suitable predetermined number for sponsored slots. In some embodiments, after all the recommendations and/or items have been filtered using standardization and ranking, the items can be processed through the rules engine to determine whether or not the items quality for a premium slot or general slot (e.g., first segment slot or second segment slot).

In several embodiments, FIG. 5 additionally can include an activity 520 of matching, using a rules engine, the intent features to a first recommendation of the recommendations. In some embodiments, the first recommendation can be sponsored candidate items corresponding to the intent features of the search query. In various embodiments, the one or more first recommendations can be associated with one or more first segment slots of the slots reserved for items sponsored by a vendor and/or a third-party. In several embodiments, the first segment slots can be premium slots that can be presented as the top number of slots on a first page of a webpage and/or can be interspersed below the fold among multiple second slots (e.g., general slots). In some embodiments, the second segment slots also are presented on the webpage in a predetermined sequence.

As an example, ten premium slots can be reserved for sponsored items that match the intent features of a search query. Each of the ten premium slots can be located in different numbered slots. In following the example, the top four slots displayed first at the top of the web page can be first sponsored items viewed by the user above the fold of the webpage (e.g., first segment slots). The remaining six slots for sponsored slots can be located at other numerical slots such as 11-12 and 15-19 below the fold (second segment slots).

In many embodiments, the one or more first recommendations of the one or more recommendations can include sponsored candidate items corresponding to the one or more intent features of the search query. In some embodiments, sponsors of the sponsored candidate items can include vendors, sellers, and/or another suitable third-parties that sell candidate items.

In several embodiments, the rules engine can include business rules with matching logic. In some embodiments, the one or more business rules can include rules for determining feature intents (e.g., intents) such as an age intent, a color intent, a gender intent, a size intent, and/or another suitable query intent. In several embodiments, the rules engine also can perform creating standardize terms used in descriptions of items. In some embodiments, when one or more business rules are overruled by the machine learning models, one or more new business rules can be added or deleted to the rules engine to correct logic errors in the matching logic for groups of queries.

In many embodiments, activity 520 further can include analyzing whether or not the intents of the candidate items match the feature intents (search queries) for query-item pairs can include following hard filter rules 410 (FIG. 4), and/or soft filter rules 420 (FIG. 4). In some embodiments, when all the candidate intents match the feature intents of a query-item pair, the rules engine qualifies the query-item pair for a premium slot (first segment slots) of the predetermined number of premium slots. In several embodiments, assigning the location and position of the qualified candidate item is discussed in further detail in connection with activity 530. In several embodiments, activity 525 can be implemented as described above in connection with hard filter rules 410 (FIG. 4).

In various embodiments, when the intents in a candidate item do not match each of the feature intents in the search query, using soft filter rules, the rules engine does not qualify the query-item pair for the premium slot (first segment slots), however the same query-item pair can be qualified for the general slots (second segment slots) based on machine learning. In several embodiments, the unqualified query-item pair can be further analyzed using an ensemble of machine learning models.

In several embodiments, activity 525 also can be implemented as described above in connection with soft filter rules 420 (FIG. 4).

In a number of embodiments, FIG. 5 also can include an activity 525 of generating, using a machine learning model, a second recommendation. In various embodiments, the second recommendation can be associated with (i) second segment slots or (ii) remaining slots of the first segment slots. In various embodiments, the second recommendation can be generated using remaining recommendations in the group of recommendations, as retrieved. In some embodiments, the group of recommendations can include recommendations qualified for a premium slot or qualified for a general slot. In many embodiments, the recommendations as retrieved can be stored in a database or cache. In some embodiments, the machine learning model can use an ensemble of semantic embeddings and categorical intents matching to determine whether the candidate item qualifies for the premium slots or the general slots.

In various embodiments, generating the second recommendation can include overriding the rules engine. In several embodiments, generating the one or more second recommendations can include using the machine learning model to determine whether or not to (i) overrule the rules engine and qualify the same query-item pair that was not qualified by the rules engine for the premium slot or (ii) to qualify a query-item pair for the general slots.

In several embodiments, upon receiving an overrule command, activity 525 also can automatically generate a new rule based on the output of the machine learning model to update the rules engine 406 (FIG. 4) and/or automatically generate a new standardized term to update the rules engine database storing standardize terms. In several embodiments, automatically adding or deleting rules to correct logic errors can be implemented as a feedback loop into the rules engine.

In some embodiments, predicting, using a decision-tree based machine learning model, to predict whether or not an item of a query-item pair can re-qualify for the premium slots. In various embodiments, if the item does not re-qualify for the premium slots, the item still qualifies for the general slots. In some embodiments, the decision-tree based machine learning model can include XGBoost. In several embodiments, the decision-tree based machine learning model can use both implicit features and explicit features from the query-item pair. In many embodiments the machine learning model also can include a random forest model.

In a number of embodiments, training data used to train the decision-tree based machine learning model can include at least historical search queries, historical intents assigned to terms in search queries, historical query-item relevance scores, historical bids, historical items tagged as true or false, over a predetermined period of time, and/or another suitable historical data point. In some embodiments, the decision-tree machine learning model can predict or classify whether the query-item pair qualifies for a premium slot or a general slot. In various embodiments, output from the decision-tree machine learning model is reused in a feedback loop to the original training data to re-train the training data to improve the accuracy and speed of the machine learning model.

In various embodiments, the decision-tree based machine learning model can retrieve data from the implicit features and explicit features in an explicit form and/or an implicit form. In many embodiments, implicit features can include embedding vectors of 384 dimensions that are cached in embedding caches ready to be fetched. In several embodiments, explicit features can include intent keywords of an item description such as: {Product_type: [String], Color: [String], Age: [String], Gender: [String], Size: [String], Text: [String]}. In some embodiments, Table 1 also shows examples of implicit features of the item for the item and the query side analysis including Bert_embedding_1: Vector, or Bert_embedding_2: Vector.

In several embodiments, transforming, using feature transformation, each of the implicit features and explicit features from the query side and item side (query-item pair) into a feature vector. In many embodiments, the transformation logic can generate a feature vector element for each implicit feature and explicit feature. In several embodiments, machine learning models interpret the feature vector elements as part of the analysis of input data.

In various embodiments, Table 2 shows examples of both implicit and explicit feature inputs transformed using feature transformation logic.

In various embodiments, each of the feature vector elements can be input into the decision-tree based machine learning model (e.g., XGBoost) to output a relevance score in the range of 0 to 1. As an example, the relevance score of 0.9 is a strong match (relevant) qualifying the query-item pair for a premium slot while a relevance score of 0.1 is not a strong match qualifying the query-item pair for a general slot.

In a number of embodiments, training data used to train the decision-tree based machine learning model can be based on at least historical search queries, historical intents assigned to terms in search queries, historical query-item relevance scores, historical bids, historical items tagged as true or false, over a predetermined period of time, and/or another suitable historical data point. In some embodiments, the decision-tree based machine learning model can transform, predict or classify whether the query-item pair qualifies for a premium slot or a general slot. In various embodiments, output from the decision-tree based machine learning model is reused in a feedback loop to the original training data to re-train the training data to improve the accuracy and speed of the machine learning model.

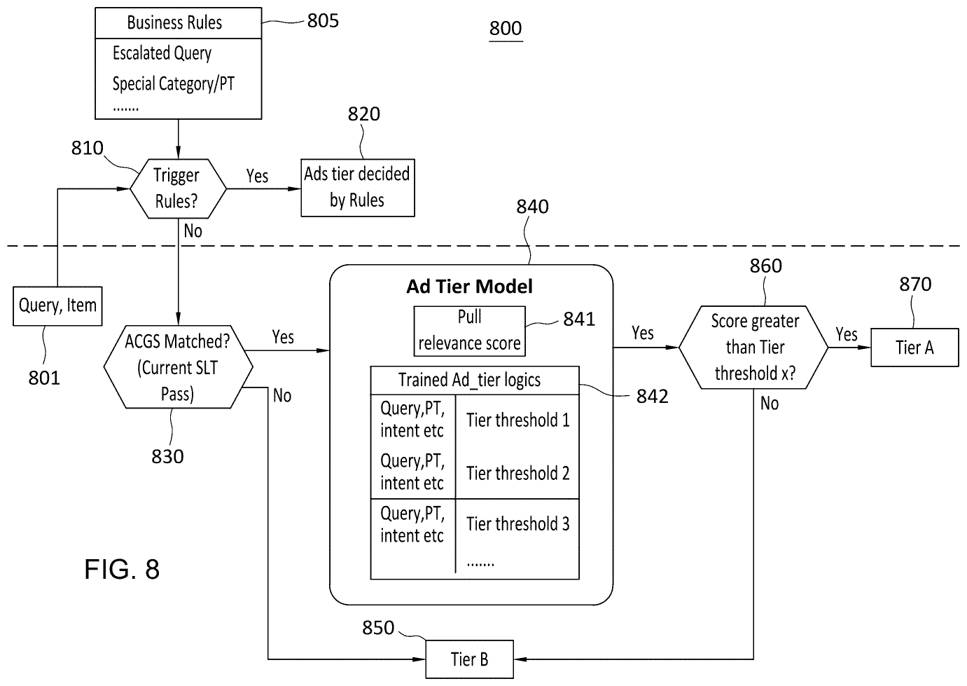

In a number of embodiments, activity 525 further can include generating a trained Tier logic table (ad tier logic table) to define one or more tier thresholds for various items. In several embodiments, activity 525 of generating a trained Tier logic table and Tier thresholds can be implemented as described above in connection with logic table 842 (FIG. 8).

In several embodiments, FIG. 5 further can include an activity 530 of populating the one or more first segment slots and the one or more second segment slots on a webpage corresponding to the one or more intent features of the search query.

Generally, a webpage or search page can be configured to display or show multiple slots including premium slots and organic slots in response to a search query. The premium slots can be a predetermined number reserved or used as placeholders for sponsored items or recommendations. In several embodiments, a separate search other than the search for sponsored items can be conducted as an organic search in response to the query search terms. As an example, a webpage can show more than fifty slots in response to a search query and of those fifty slots, ten slots are reserved for sponsored items. In various embodiments, of the ten slots reserved for sponsored items, a predetermined number of slots at the top of the webpage are placeholders for premium slots and the remaining number of slots of the ten slots are placeholders for general slots. In following the example, of the remaining forty slots on the webpage, each slot can be populated with items from an organic search where each of the items identified as matching the query intents are not sponsored by vendors. In some embodiments, an organic search is conducted outside of the sponsored search.

In some embodiments, FIG. 5 also can include optionally and/or alternately can include an activity 535 of generating a bidding process for the one or more first segment slots and the one or more second segment slots. In various embodiments, the bidding process is triggered once the items to be shown in the one or more first segment slots are identified, then activity 535 can initiate or begin a configurable dynamic-reserve 2-phase second price auction. In some embodiments, the dynamic-reserve 2-phase second price auction includes digital communications between the vendors or third parties to enter bids for placement of the sponsored item prior to displaying the webpage to the user. In many embodiments, activity 535 can introduce separate auctions for the two segments and combine them in a way that does not significantly impact ad revenue. In several embodiments, generating the bidding process can occur in real or near real-time prior to transmitting the search page in response to the search query.

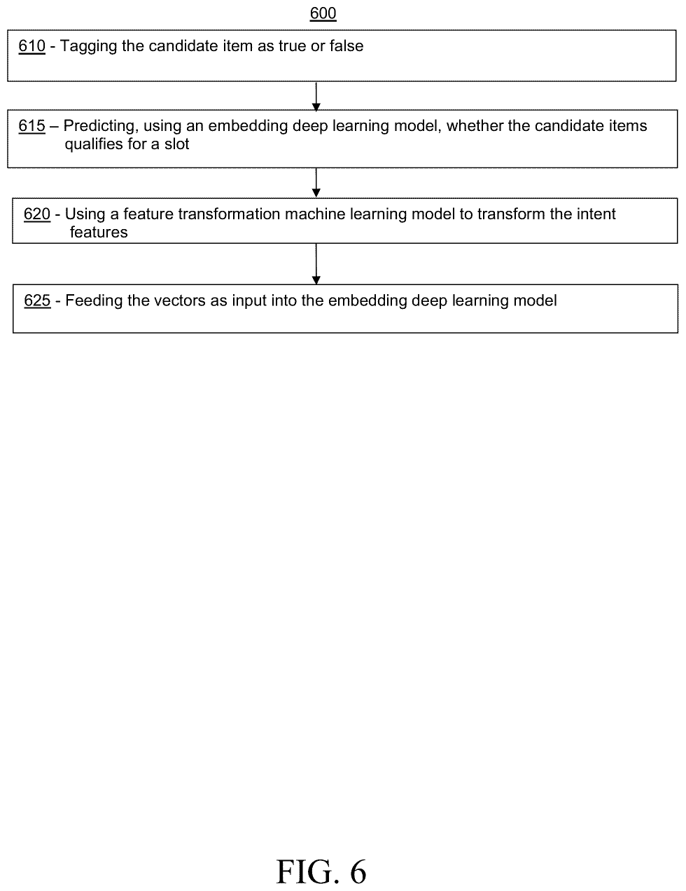

Turning ahead in the drawings, FIG. 6 illustrates a flow chart for a method 600 of generating a second recommendation, according to another embodiment. In some embodiments, method 600 also can be a method of predicting, using machine learning and vectors for the query-item pair, to determine whether or not the item or recommendation of the query-item pair qualifies for a premium slot. Method 600 is merely an example and is not limited to the embodiments presented herein. Method 600 can be utilized in many different embodiments and/or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped. In several embodiments, system 300 (FIG. 3) can be suitable to perform method 600 and/or one or more of the activities of method 600.

In these or other embodiments, one or more of the activities of method 600 can be implemented as one or more computing instructions configured to run at one or more processors and configured to be stored at one or more non-transitory computer-readable media. Such non-transitory computer-readable media can be part of a computer system such as content filtering system 310 and/or web server 320. The processor(s) can be similar or identical to the processor(s) described above with respect to computer system 100 (FIG. 1).

Turning to the drawings, FIG. 6 can include an activity 610 of tagging the candidate item as true or false. In some embodiments, tagging can include recognizing and assigning a digital tag or machine-readable marker to an item sponsored by a vendor or third party retrieved from a database or cache as to whether or not the item matches at least a number of intents in a search query. In some embodiments, a tag marked as true can indicate that at least a number of intents of the item match at least a number of intents in a search query. In several embodiments, a tag marked as false can indicate that none of the intent features match the candidate item. In several embodiment, each candidate item retrieved is tagged with information as to whether or not the query intents and the item information match (e.g., query side and item side) and each candidate items, as tagged, is stored in a database or cache. For example, if a size intent is identified in a query, the search engine search for a diaper with a numerical size value five (5) and the search engine retrieves a size six (6) diaper with a numerical value of six (6). In this example, while the item retrieved covered the size intent on the item side, the size six (6) diaper is not a match for the query side. In several embodiments, when a candidate item is retrieved with no size information, then the candidate item is tagged as not a match for the size intent on the query side.

In some embodiments, tagging each candidate item can be advantageous to rule in or rule out relevant candidate items that can be used as input into the rules engine and/or a machine learning model to determine whether candidate items match the query search intents. In several embodiments, when the item is a match, the rules engine and/or the machine learning model can determine whether or not the item qualifies for a premium slot and/or a general slot. In several embodiments, once the items of the query-item pair are determined, conducting, a configurable dynamic-reserve 2-phase second price auction process to determine a location and/or order of the items placed into each premium slot and/or a general slot in real-time or near real-time prior to transmitting the information to the user.

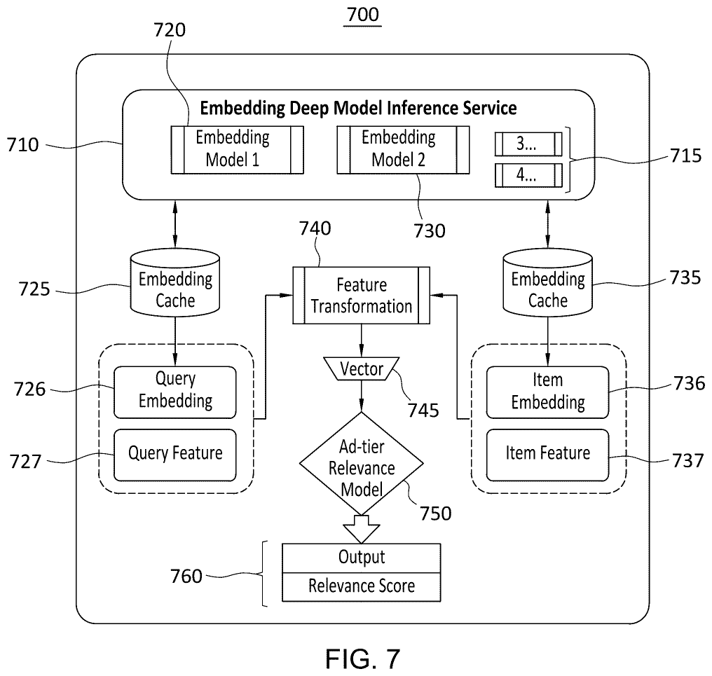

Referring to the drawings, FIG. 6 can include an activity 615 of predicting, using an embedding deep learning model, whether the candidate item, as tagged, qualifies for a slot of the first segment slots. In several embodiments, activity 615 of embedding terms and/or features in the query side and item side into embedded metrics can be implemented as described above in connection with query embedding 726 (FIG. 7) and item embedding 736 (FIG. 7).

In a number of embodiments, training data used to train the embedding deep learning machine learning model can be based on at least text or images from historical search queries, historical intents assigned to terms in search queries, historical query-item relevance scores, historical bids, historical items tagged as true or false, over a predetermined period of time, and/or another suitable historical data point. In some embodiments, the embedding deep learning machine learning model can predict or classify whether the query-item pair qualifies for a premium slot. In various embodiments, the output from the embedding deep learning model can be transformed into respective vectors and/or another suitable machine readable metrics. In some embodiments, the output from the embedding deep learning machine learning model can be further reused in feedback loop to the original training data to re-train the training data to improve the accuracy and speed of the machine learning model.

In some embodiments, FIG. 6 also can include an activity 620 of transforming, using a feature transformation machine learning model to transform the intent features from textual formats to vectors. In several embodiments, activity 620 of transforming the embedded terms and/or features of both the query side and item side into vectors 745 used as input into machine learning can be implemented as described above in connection with activity 740 (FIG. 7).

In several embodiments, FIG. 6 further can include an activity 625 of feeding, using the embedding deep learning model, the vectors as input into the embedding deep learning model to output a relevance score with a range of zero (0) to one (1). In several embodiments, activity 625 can be implemented as described above in connection with activity 750 (FIG. 7).

Turning ahead in the drawings, FIG. 7 illustrates a flow chart of a method 700 of predicting a relevance score for a query-item pair. Method 700 can be used in implementing an embodiment of method 700. Method 700 can be utilized in many different embodiments and/or examples not specifically depicted or described herein. In some embodiments, the procedures, the processes, and/or the activities of method 700 can be performed in the order presented or in parallel. In other embodiments, the procedures, the processes, and/or the activities of method 700 can be performed in any suitable order. In still other embodiments, one or more of the procedures, the processes, and/or the activities of method 700 can be combined or skipped.

In many embodiments, method 700 can begin by activity 710 of using an embedding deep model inference service to embed text and/or items of each query-item pair. In some embodiments, activity 710 can embed a query feature 727 and/or an item feature 737 by using one of one or more embedding models 720, 730, and/or 715. In several embodiments, the vectors can include 384 dimensions.

In some embodiments, method 700 can include activity 725 of storing embedding query features output from the one or more embedding models in an embedding cache. In various embodiments, activity 735 also can include storing embedding item features output from the one or more embedding models in an item embedding cache. In various embodiments, Table 1 shows examples of query features of the query for the query side of the analysis including product type, color, age, gender, size, and/or another suitable explicit feature.

In various embodiments, method 700 also can include embedding text of item features 737 where the item features are explicit features of the item also using the one of one or more embedding models 720, 730, and/or 715 of an embedding deep model inference service. In some embodiments, Table 1 shows examples of explicit features of the item for the item side of the analysis including product type, color, age, gender, size, and/or another suitable explicit feature.

In several embodiments, method 700 also can include activity 740 of transforming, using a feature transformation machine learning model, each of query embedding 726 and item embedding 736 into vectors 745.

In some embodiments, activity 740 can proceed to activity 750 of predicting, using a decision-tree based machine learning model (e.g., XGBoost) to generate a relevance score 760 of the query-item pair. In various embodiments, generating by inputting the one or more digital vectors 745 into the decision-tree based machine learning model (e.g., Ad-tier relevance model), an output of a relevance score of the query-item pair.

In many embodiments, method 700 can include an activity 750 of generating, using a relevance machine learning model, a relevance score for each recommendation, according to an embodiment. In several embodiments, predicting, using the relevance machine learning model, whether or not the similarity between the intent features and query-item pair qualifies the item for a premium slot. In some embodiments, the relevance machine learning model can include using an XGBoost machine learning model.

TABLE 1
Inputs and outputs to the Embedding
Deep Model Inference Service

| | | Output |
|---|---|---|
| Query Side | Item Side | Relevance Score |
| { | { | Float range [0,1] |
| Bert_embedding_1: | Bert_embedding_1: | |
| Vector, | Vector, | |
| Bert_embedding_2: | Bert_embedding_2: | |
| Vector, | Vector, | |
| Product_type: [String], | Product_type: [String], | |
| Color: [String], | Color: [String], | |
| Age:[String], | Age:[String], | |
| Gender:[String], | Gender:[String], | |
| Size: [String], | Size: [String], | |
| query_text: String | item_text: String | |
| } | } | |

TABLE 2
Transformed Inputs to Features

| | Input Feature Transform Logics |
|---|---|
| Query-item | dot product for cosine similarity score [0, 1] |
| Bert_embedding_i | |
| Product_type | Boolean match 0/1 |
| Color | Boolean match 0/1 |
| Age | Boolean match 0/1 |
| Gender | Boolean match 0//1 |
| Size | Boolean match 0/1 |
| query_text, item_text | Jaccard overlap score [0, 1] |

Jumping ahead in the drawings, FIG. 8 illustrates a flow chart for a method 800 of predicting whether the second items qualify for sponsored slots (e.g., premium or general slots), according to an embodiment. Method 800 further can illustrate how to predict, using an ensemble of machine learning models, whether the second items quality for sponsored slots based on using a relevance score for a query-item pair. Method 800 also can include generating a trained tier logic table with multiple tier threshold levels associated with a type of query, product type, an intent, and/or another suitable feature. Method 800 additionally can include using multiple embedding models to embed query features and item features that can be transformed into multiple vectors using a feature transformation model. Method 800 can be utilized in many different embodiments and/or examples not specifically depicted or described herein. In some embodiments, the procedures, the processes, and/or the activities of method 800 can be performed in the order presented or in parallel. In other embodiments, the procedures, the processes, and/or the activities of method 800 can be performed in any suitable order. In still other embodiments, one or more of the procedures, the processes, and/or the activities of method 800 can be combined or skipped.

In many embodiments, method 800 can begin with an activity 805 of first analyzing, using rules of the rules engine, whether or not a query-item pair 801 qualifies for a premium slot (e.g., sponsored slot). In many embodiments, the premium slots can also be referred to as a Tier A (slot 870) and/or first segment slots.

In some embodiments, method 800 can include an activity 810 of using trigger rules to determine whether or not to qualify the query-item pair for premium slots. If activity 810 is yes, method 800 can proceed rules 820 qualifying the query-item pair for the premium slots. Otherwise, activity 810 is no, method 800 can proceed to activity 830 of predicting, using an ensemble of machine learning models, whether or not the query-item pair qualifies for a premium slot or a general slot (e.g., a first segment slot and/or a second segment slot). In several embodiments, activity 810 can be implemented as described above in connection with activity 525 (FIG. 5).

In various embodiments, method 800 can include an activity 830 of determining, using ensemble machine learning, whether or not to qualify the query-item pair match for a premium slot. If the output of activity 830 is yes, method 800 can proceed to using a machine learning model 840. As an example, machine learning model 840 can include XGBoost (e.g., Ad Tier Model), random forest model, or another suitable deep learning model. Otherwise, if the output of activity 830 is no, method 800 can proceed to slot 850 of storing the query-item pair for placement in one of the general slots reserved for the sponsored items. In many embodiments, the general slots can also be referred to as a Tier B or second segment slots. In several embodiments, the recommendations qualifying for Tier B also can be populated in Tier A when there are empty Tier A slots or if the recommendation is re-qualified to Tier A using machine learning and/or triggered from a Tier B to a Tier A by implementing new or deleted rules.

In a number of embodiments, training data used to train the random forest learning machine learning model can based on at least historical search queries, historical intents assigned to terms in search queries, historical query-item relevance scores, historical bids, historical items tagged as true or false, over a predetermined period of time, and/or another suitable historical data point. In some embodiments, the random forest learning machine learning model can transform predict or classify whether the query-item pair qualifies for a premium slot or a general slot. In various embodiments, output from the random forest learning machine learning model is reused in feedback loop to the original training data to re-train the training data to improve the accuracy and speed of the machine learning model.

In many embodiments, using machine learning model 840 can include an activity 841 of retrieving a relevance score for the query-item pair, such as relevance score 760 (FIG. 7). In several embodiments, method 800 can proceed after activity 841 to an activity of generating a logics table 842.

In some embodiments, logics table 842 can be generated, using machine learning, predictions for thresholds based on different query-item pairs using both implicit data and explicit data. In many embodiments, training data for the machine learning model can include historic queries, product types, query intents and other data points. As an example, a Tier threshold 1 can be for a “cereal type” for be threshold value of 0.7 indicating a score <0.7 greater than 0.7 qualifies the item (cereal) for placement in a premium slot. In following with the example, a Tier threshold 2 can be used for a tail query such as a “toys for a 3-year old boy” for a threshold value be 0.7 however, each than threshold 0.7 can also qualify the item (toys for a 3-year old boy) for placement in a premium slot. In this example, determining thresholding levels take into account different query-item pairs due to the different implicit and explicit training data used as input.

In some embodiments, generating a trained tier logics table based on the threshold levels predictions for each query-item pair can be used to fine tune the ensemble machine learning models of activity 830 by adding a granular analysis for each Tier level. In many embodiments, logics table 842 can also include generating a placement location for each query-item pair qualified for a premium slot and/or a general slot.

In several embodiments, method 800 can proceed after machine learning model 840 to a tier threshold score 860.

In various embodiments, machine learning model 840 can out put a tier threshold score of a query-item pair. In many embodiments, the query-item that exceeds a tier threshold score 860 can be qualified and displayed in a slot 870. In many embodiments, the premium slots are also referred to as a Tier A or first segment slots.

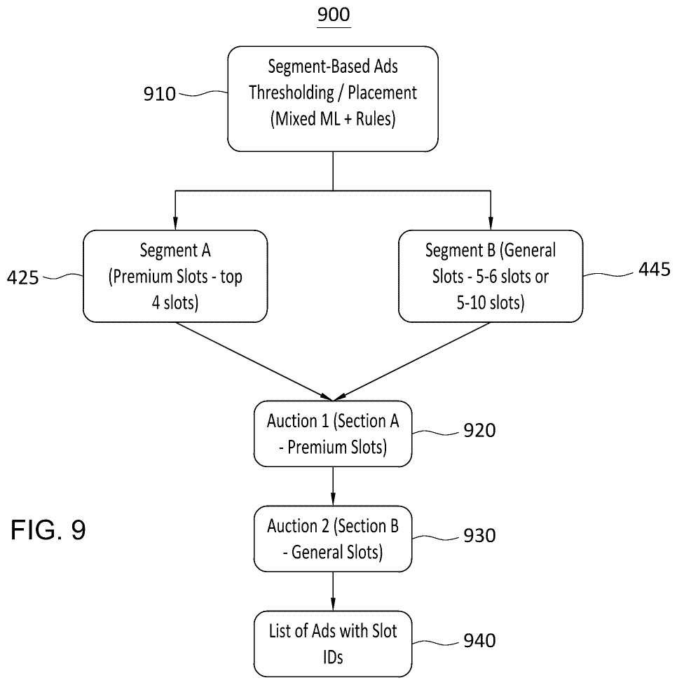

Turning to the drawings, FIG. 9 illustrates a block diagram for a method 900 of a configurable dynamic-reserve 2-phase second price auction, according to an embodiment. Method 900 can be similar or identical to the activities described in 535 (FIG. 5). Method 900 can be used in many different embodiments and/or examples not specifically depicted or described herein. In some embodiments, the procedures, the processes, and/or the activities of method 900 can be performed in the order presented or in parallel. In other embodiments, the procedures, the processes, and/or the activities of method 900 can be performed in any suitable order. In still other embodiments, one or more of the procedures, the processes, and/or the activities of method 900 can be combined or skipped. In several embodiments, system 300 (FIG. 3) can be suitable to perform method 900 and/or one or more of the activities of method 900.

In these or other embodiments, one or more of the activities of method 900 can be implemented as one or more computing instructions configured to run at one or more processors and configured to be stored at one or more non-transitory computer-readable media. Such non-transitory computer-readable media can be part of a computer system such as content filtering system 310 and/or web server 320. The processor(s) can be similar or identical to the processor(s) described above with respect to computer system 100 (FIG. 1).

In several embodiments, method 900 can begin with a set of items 910 where each of the item in the set of items matched at least one of the intents in the search query. In many embodiments, method 900 can proceed after the set of items 910 to first segment slots 425 (FIG. 4) and/or second segment slots 445 (FIG. 4) to conduct a two-segment auction. In many embodiments, the two-segment auction can be implemented using an auction 920 and an auction 930. In several embodiments, auction 920 receives bids for recommendations associated with first segment slots 425 in real-time or near real-time prior to populating the premium slots. In various embodiments, auction 930 received bids for recommendations associated with second segment slots 445 in real-time or near real-time prior to populating the premium and/or general slots. In some embodiments, ranked list 940 lists the winning bid for each recommendation including the location and position of the recommendation displayed in the premium slots and/or general slots where each of the recommendations are uploaded into the respective slots and displayed to a user or customer on a webpage in response to the search query in real or near real time.

Returning to FIG. 3, communication system 311 can at least partially perform activity 510 (FIG. 5) of identifying intent features within multiple terms of a search query.

In many embodiments, rules system 312 can at least partially perform activity 510 (FIG. 5) standardizing terms into a central or common framework by mapping the one or more context intents into a common group or list.

In some embodiments, machine learning system 313 can at least partially perform activity 525 (FIG. 5) generating, using a machine learning model, a second recommendation, and/or activity 615 (FIG. 6) predicting, using an embedding deep learning model, whether the candidate item, as tagged, qualifies for a slot of the first segment slots.

In several embodiments, identification system 314 can at least partially perform activity 515 (FIG. 5) retrieving recommendations mapped to a candidate item based on the intent features, and/or activity 515 (FIG. 5) ranking, using a ranking algorithm, the items for a top number of items that qualify as matches to the query terms.

In a number of embodiments, relevance system 315 can at least partially perform activity 750 (FIG. 7) generating, using a relevance machine learning model, a relevance score for each recommendation.

In various embodiments, tagging system 316 can at least partially perform activity 520 (FIG. 5) of matching, using a rules engine, the intent features to a first recommendation of the recommendations, wherein the first recommendation is associated with first segment slots and/or activity 610 (FIG. 6) tagging the candidate item as true or false.

In some embodiments, embedding system 317 can at least partially perform activity 710 (FIG. 7) of using an embedding deep model inference service to embed text and/or items of each query-item pair.

In several embodiments, cache system 318 can at least partially perform activity 725 of storing embedding query features output from the one or more embedding models in an embedding cache, and/or activity 735 also can include storing embedding item features output from the one or more embedding models in an item embedding cache.

In many embodiments, transformation system 319 can at least partially perform activity 620 (FIG. 6) using a feature transformation machine learning model to transform the intent features from textual formats to vectors, and/or activity 740 (FIG. 7) of transforming, using a feature transformation machine learning model, each of query embedding 726 (FIG. 7) and item embedding 736 (FIG. 7) into vectors 745 (FIG. 7).

In various embodiments, scoring system 322 can at least partially perform activity 625 (FIG. 6) feeding the vectors as input into the embedding deep learning model to output a relevance score with a range of 0 to 1, and/or activity 750 (FIG. 7) of predicting, using an XG Boost model to generate a relevance score of the query-item pair.

In some embodiment, auction system 323 can at least partially perform activity 535 (FIG. 5) of generating a bidding process for the one or more first segment slots and the one or more second segment slots.

In a number of embodiments, display system 324 can at least partially perform activity 530 of populating the first segment slots and the second segment slots on a webpage corresponding to the intent features of the search query.

In several embodiments, web server 320 can include a webpage system 321. Webpage system 321 can at least partially perform sending instructions to user computers (e.g., 350-351 (FIG. 3)) based on information received from communication system 311.

In many embodiments, the techniques described herein can be used continuously at a scale that cannot be handled using manual techniques. For example, the number of daily and/or monthly visits to the content source can exceed approximately ten million and/or other suitable numbers, the number of registered users to the content source can exceed approximately one million and/or other suitable numbers, and/or the number of products and/or items sold on the website can exceed approximately ten million (10,000,000) approximately each day.

In a number of embodiments, the techniques described herein can solve a technical problem that arises only within the realm of computer networks, as determining whether a sponsored item matches the multiple intents of a search query does not exist outside the realm of computer networks. Moreover, the techniques described herein can solve a technical problem that cannot be solved outside the context of computer networks. Specifically, the techniques described herein cannot be used outside the context of computer networks, in view of a lack of data, and because a content catalog, such as an online catalog, that can power and/or feed an online website that is part of the techniques described herein would not exist.

Although automatically filtering content items to match intentions identified in a search query has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 may be modified, and that the foregoing discussion of certain of these embodiments does not necessarily represent a complete description of all possible embodiments. For example, one or more of the procedures, processes, or activities of FIGS. 4-9 may include different procedures, processes, and/or activities and be performed by many different modules, in many different orders, and/or one or more of the procedures, processes, or activities of FIGS. 4-9 may include one or more of the procedures, processes, or activities of another different one of FIGS. 4-9. As another example, performing communication system 311, rules system 312, machine learning system 313, relevance system 315, tagging system 316, embedding system 317, caches system 318, transformation system 319, scoring system 322, auction system 323, display system 324, webserver 320 and/or webpage system 321. Additional details regarding communication system 311, rules system 312, machine learning system 313, relevance system 315, tagging system 316, embedding system 317, caches system 318, transformation system 319, scoring system 322, auction system 323, display system 324, webserver 320 and/or webpage system 321 (see FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system comprising:
a processor; and
a non-transitory computer-readable medium storing computing instructions that, when executed on the processor, cause the processor to execute operations comprising:
identifying intent features of a search query;
using a first machine learning model to determine whether recommendations, mapped to a candidate item, qualify for one or more of first segment slots or second segment slots based on an extent of matching intent features of a search query entered via a user computer;
using a second machine learning model to generate a relevance score for a query-item pair with standardized terms in both a query side based on the search query and an intent side based on the intent features of the search query; and
populating the first segment slots and the second segment slots on a webpage, corresponding to the intent features of the search query, based on using the first machine learning model to determine whether the recommendations qualify for the one or more of the first segment slots or the second segment slots and based on using the second learning machine learning model to generate the relevance score for the query-item pair.

2. The system of claim 1, wherein the intent features comprise at least one of an age, a size, a color, a gender, or a brand.

3. The system of claim 1, wherein using the first machine learning model comprises:
tagging the candidate item as true or false, wherein true indicates the intent features match the candidate item; and
predicting, using an embedding deep learning model, whether the candidate item, as tagged, qualifies for a slot of the first segment slots.

4. The system of claim 2, wherein the relevance score is within a range of 0 to 1.

5. The system of claim 1, wherein the recommendations include a first recommendation comprising sponsored candidate items corresponding to the intent features of the search query.

6. (canceled)

7. The system of claim 1, wherein the first segment slots comprise a predetermined number of slots presented at a top of the webpage.

8. (canceled)

9. The system of claim 1, wherein the second segment slots are presented on the webpage in a predetermined sequence.

10. The system of claim 1, wherein the operations further comprise:
generating a bidding process for the first segment slots and the second segment slots.

11. A computer-implemented method comprising:
identifying intent features of a search query;
using a first machine learning model to determine whether recommendations, mapped to a candidate item, qualify for one or more of first segment slots or second segment slots based on an extent of matching intent features of a search query entered via a user computer;
using a second machine learning model to generate a relevance score for a query-item pair with standardized terms in both a query side based on the search query and an intent side based on the intent features of the search query; and
populating the first segment slots and the second segment slots on a webpage, corresponding to the intent features of the search query, based on using the first machine learning model to determine whether the recommendations qualify for the one or more of the first segment slots or the second segment slots and based on using the second learning machine learning model to generate the relevance score for the query-item pair.

12. The computer-implemented method of claim 11, wherein the intent features comprise at least one of an age, a size, a color, a gender, or a brand.

13. The computer-implemented method of claim 11, wherein using the first machine learning model comprises:
tagging the candidate item as true or false, wherein true indicates the intent features match the candidate item; and
predicting, using an embedding deep learning model, whether the candidate item, as tagged, qualifies for a slot of the first segment slots.

14. The computer-implemented method of claim 13 further comprising:
using a feature transformation machine learning model to transform the intent features from textual formats to vectors before feeding the vectors as input to output the relevance score.

15. The computer-implemented method of claim 11, wherein the recommendations include a first recommendation comprising sponsored candidate items corresponding to the intent features of the search query.

16. (canceled)

17. The computer-implemented method of claim 11, wherein the first segment slots comprise a predetermined number of slots presented at a top of the webpage.

18. (canceled)

19. A non-transitory computer-readable medium storing computing instructions that, when executed on a processor, cause the processor to execute operations comprising:
identifying intent features of a search query;
using a first machine learning model to determine whether recommendations, mapped to a candidate item, qualify for one or more of first segment slots or second segment slots based on an extent of matching intent features of a search query entered via a user computer;
using a second machine learning model to generate a relevance score for a query-item pair with standardized terms in both a query side based on the search query and an intent side based on the intent features of the search query; and
populating the first segment slots and the second segment slots on a webpage, corresponding to the intent features of the search query, based on using the first machine learning model to determine whether the recommendations qualify for the one or more of the first segment slots or the second segment slots and based on using the second learning machine learning model to generate the relevance score for the query-item pair.

20. The non-transitory computer-readable medium of claim 19, wherein using the first machine learning model comprises:
tagging the candidate item as true or false, wherein true indicates the intent features match the candidate item; and
predicting, using an embedding deep learning model, whether the candidate item, as tagged, qualifies for a slot of the first segment slots.

21. The computer-implemented method of claim 11, wherein the first machine learning model includes a decision tree learning model.

22. The computer-implemented method of claim 11, wherein the second machine learning model includes a deep learning machine learning model configured to generate the relevance score for the query-item pair.

23. The computer-implemented method of claim 11, wherein the second machine learning model further includes a deep learning global machine learning model configured to generate a quality score for the query-item pair.

24. The computer-implemented method of claim 11,
wherein the search query includes multiple terms with multiple intents, and
wherein an intent, of the multiple intents, is mappable to one or more candidate items that include the candidate item.
